(19) United States
(12) Patent Application Publication
(10) Pub. No.: US 2001/0010857 A1
(43) Pub. Date: Aug. 2, 2001

(54) Resin substrate for optical use

(76) Inventors: Nobuyoshi Yagi, Osaka (JP); Minoru Miyatake, Osaka (JP); Toshiyuki Umehara, Osaka (JP); Yoshimasa Sakata, Osaka (JP); Kiichi Shimodaira, Osaka (JP)

Correspondence Address: SUGHRUE, MION, ZINN, MACPEAK & SEAS, PLLC, 2100 Pennsylvania Avenue, N.W., Washington, DC, 20037, US

(21) Appl. No.: 09/769,376

(22) Filed: Jan. 26, 2001

(30) Foreign Application Priority Data
Jan. 31, 2000 (JP) P. 2000-021313

(51) Int. Cl. B32B 3/26

(52) U.S. Cl. 428/142; 428/141

(57) ABSTRACT

A resin substrate for optical use is described, which comprises a multilayer structure (5, 6, 7) having a surface roughness Rₐ of 0.8 nm or lower on at least one side and having an average thickness of from 100 to 800 μm.

### FIELD OF THE INVENTION

The present invention relates to a resin substrate for optical use which has excellent surface smoothness and is suitable for use as, e.g., a cell substrate or the cover of a touch panel, electromagnetic shield, or solar cell.

### BACKGROUND OF THE INVENTION

STN liquid crystals and ferroelectric liquid crystals are expected to be promising materials because of their quick-response properties, etc. Under these circumstances, there is a desire for a cell substrate having excellent surface smoothness which can be advantageously used in forming a cell employing such a liquid crystal. This is because high surface roughness tends to result in alignment defects, such as Williams domains, which considerably influence display quality including contrast and visibility. Cell substrates are desired to have a surface roughness Rₐ of 0.8 nm or lower.

However, the conventional glass substrates finished by polishing and the conventional resin substrates formed by casting have had a problem that they usually have a surface roughness Rₐ of 10 nm or higher because of unevenness of polishing or a reflection of the surface roughness of the casting plate and hardly attain the desired surface roughness shown above. Another drawback of the conventional substrates is that the polishing and casting are unsuitable for mass production, necessitate much labor for the operation and maintenance of these techniques, and have a low efficiency of substrate production.

### SUMMARY OF THE INVENTION

An object of the invention is to develop a substrate which has a surface roughness Rₐ of 0.8 nm or lower, can be produced highly efficiently, and is suitable for use in optical applications.

The invention provides a resin substrate for optical use which comprises a multilayer structure having a surface roughness Rₐ of 0.8 nm or lower on at least one side and having an average thickness of from 100 to 800 μm.

### BRIEF DESCRIPTION OF THE DRAWING

FIG. 1 is a view illustrating an example of a production process.

### DESCRIPTION OF REFERENCE NUMERALS

1: support (endless belt)

2, 3: driving and subsidiary drums

4: curing apparatus

5: easily peelable resin layer

6: superposed layer

7: base layer

51, 61, 71: dies

52, 62, 72: spread layers

### DETAILED DESCRIPTION OF THE INVENTION

According to the invention, the multilayered substrate can be produced by a process comprising forming an easily peelable resin layer on a support and forming a resin layer serving as the base layer of the substrate on the peelable resin layer by coating. As a result, the surface smoothness of the support having a mirror surface or the like can be satisfactorily transferred to and reflected on the easily peelable resin layer, and the multilayered substrate formed through this easily peelable resin layer can be easily peeled and recovered from the support. Furthermore, excellent surface smoothness can be attained by the formation of a free surface obtained by coating, and the base layer can be formed from a curable resin, e.g., an epoxy resin. Thus, a resin substrate for optical use having excellent surface smoothness can be produced efficiently. In addition, the attainment of a surface roughness Rₐ of 0.8 nm or lower enables the formation of a liquid-crystal cell which employs an STN liquid crystal or ferroelectric liquid crystal and has excellent display quality with respect to contrast, visibility, etc.

The resin substrate for optical use of the invention comprises a multilayer structure having a surface roughness Rₐ of 0.8 nm or lower, preferably 0.2 nm or lower on at least one side and having an average thickness of from 100 to 800 μm. This resin substrate can be produced, for example, by a method which comprises forming an easily peelable resin layer on a support having a smooth surface, e.g., a mirror surface, and spreading in a sheet form a resinous coating fluid becoming a base layer on that resin layer to form a film serving as the base layer.

For spreading the coating fluid in the method described above, a suitable technique capable of spreading the coating fluid into a sheet form can be used. Examples thereof include roll coating, spin coating, wire-wound-bar coating, extrusion coating, curtain coating, spray coating, and dip coating. By forming a free surface by this spreading, surface smoothness can be greatly enhanced to accomplish the object of the invention. Preferred from the standpoints of coating efficiency, production efficiency, etc. are flow casting techniques, in particular, extrusion coating in which a coating fluid is spread with a die.

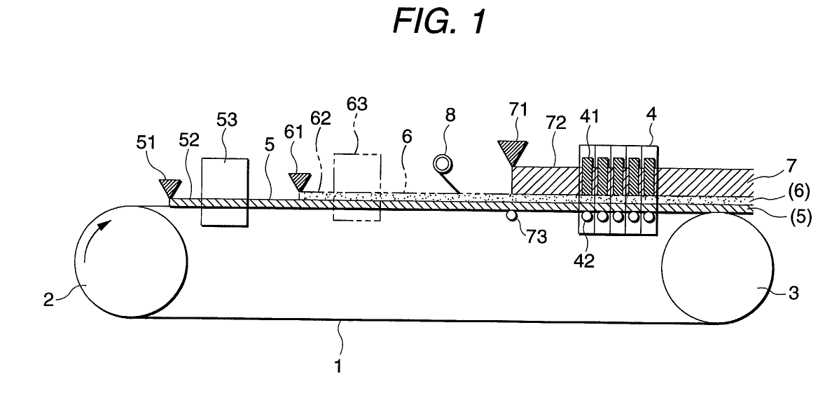

FIG. 1 illustrates an example of a continuous production process by the extrusion coating technique. In this method, a support consisting of an endless belt 1 is first caused to run in the direction indicated by the arrow by means of a driving drum 2 and a subsidiary drum 3 at a constant speed of, e.g, from 0.1 to 50 m/min, preferably from 0.2 to 5 m/min. While the support 1 is thus kept running, a coating fluid comprising or giving an easily peelable resin is continuously applied in a sheet form on the support 1 through a die 51. The resultant spread layer 52 is dried or is cured, according to need, by heating, light irradiation, etc. to obtain an easily peelable resin layer 5 consisting of a film. A reinforcing tape 8 is adhered to each edge in the width direction. In the example shown in the figure, an ultraviolet irradiator 53 is disposed.

While the easily peelable resin layer 5 is continuously formed, a resinous coating fluid is continuously applied thereon and spread into a sheet form usually having a thickness of 100 μm or larger through a die 71 disposed above the support 1 kept horizontal with a guide roll 73. This spread layer 72 is cured with a curing apparatus 4 to thereby continuously form a cured resin layer (base layer) 7 tenaciously adherent to the resin layer 5. Simultaneously with this layer formation, the cured resin layer 7 is peeled and recovered from the support 1 together with the resin layer 5 through the reinforcing tape 8. Thus, the target resin substrate for optical use is continuously produced.

By the method desired above, a resin substrate for optical use can be continuously produced through a series of simple operations. This process is highly suitable for mass production. The resin layer 5, which is the first layer formed on the substrate 1, enables the resin substrate for optical use obtained to be easily and efficiently peeled and recovered from the support. Furthermore, by regulating the traveling speed of the spread layers deposited on the support, the rate of mass production can be easily controlled. The thickness of the resin substrate for optical use to be obtained can also be easily regulated by regulating that traveling speed or the spread rate of each coating fluid.

The support can be an appropriate material having a flat surface on which the resinous coating fluids can be spread successively and continuously and which can support the spread layers while keeping the same in a sheet form. Examples thereof include belts or plates having a smooth surface, such as endless belts made of a metal such as stainless steel, copper, or aluminum or a plastic. Preferred are supports which can keep the spread layers as horizontal as possible. Especially preferred from the standpoints of suitability for rapid temperature control with a means for heating and of durability, etc. is a support having a stainless-steel surface as the surface on which the resin layers are to be spread.

The thickness of the support is suitably determined according to strength, etc. In general, the thickness thereof is from 0.1 to 10 mm. In the case of a support made of a metal, the thickness thereof is preferably from 0.5 to 2 mm from the standpoints of strength, suitability for temperature control, etc. It is also preferred to use a support having a surface roughness Rₐ of 0.02 μm or lower from the standpoint of transferring the surface state of the support to obtain a resin layer having excellent smoothness reflecting the support surface. A dam made of, e.g., a heat-resistant resin may be formed on each edge of the support for the purposes of leakage prevention, etc.

The easily peelable resin layer, which is the first layer formed on the support, is intended to enable the overlying base layer to be easily peeled from the support together with the peelable resin layer. Consequently, a resin which does not adhere to the support or which weakly adheres to the support and is easily peelable therefrom is used for forming the resin layer. This resin is not particularly limited in kind and a suitable one can be used.

Examples of the resin include urethane resins, acrylic resins, polyester resins, poly(vinyl alcohol) resins such as poly(vinyl alcohol) and ethylene/vinyl alcohol copolymers, vinyl chloride resins, vinylidene chloride resins, polyarylate resins, sulfone resins, amide resins, imide resins, polyethersulfone resins, polyetherimide resins, polycarbonate resins, silicone resins, fluororesins, polyolefin resins, styrene resins, vinylpyrrolidone resins, cellulosic resins, and acrylonitrile resins. A blend of two or more suitable resins can also be used for forming the resin layer.

The easily peelable resin layer should tenaciously adhere to the base layer, etc. and be peeled and recovered from the support together with the same to constitute a surface layer of the resin substrate for optical use. From this standpoint, the resin layer is preferably one which is excellent in optical properties including transparency. Furthermore, the resin layer is preferably one which serves as a surface coat to prevent the resin substrate for optical use from marring. Urethane resins are preferred resins usable for forming the resin layer, from the standpoints of such easy peelability, optical properties, suitability for use as a hard coat, etc., in particular from the standpoint of easy peelability from a stainless-steel support. Especially preferred is the urethane resin represented by the following chemical formula.

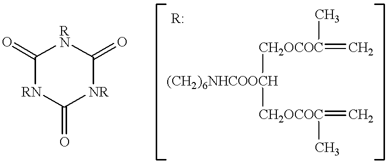

The easily peelable resin layer can be formed, for example, by the following method. An easily peelable resin is applied to a given surface of a support by an appropriate technique, e.g., any of the aforementioned ones, if desired as a solution in an appropriate solvent, e.g., an organic solvent or water. The coating is converted to a cured film by a suitable method, e.g., by curing the coating by a technique suitable for the resin, e.g., heating or light irradiation, if desired after drying the coating. Thus, the easily peelable resin layer is formed. The coating fluid used for forming the easily peelable resin layer can have a suitably determined viscosity. In general, however, the viscosity thereof is regulated to from 1 to 100 cP from the standpoints of application efficiency, even application, etc. In the case of the extrusion coating described above, a resinous fluid whose viscosity has been adjusted to from 1 to 10 cP can be advantageously used.

The thickness of the easily peelable resin layer to be formed can be suitably determined. In general, however, the thickness thereof is preferably from 1 to 10 μm, more preferably from 1 to 8 μm, most preferably from 2 to 5 μm, from the standpoints of easy peelability, cracking prevention in peeling, etc. In the case of curing a coating layer of, e.g., a urethane resin by light irradiation, it is preferred to use a high-pressure or low-pressure ultraviolet lamp having a central wavelength of 365 nm or 254 nm from the standpoints of curing efficiency, etc.

In forming the easily peelable resin layer, a suitable ingredient for improving peelability from the support can be incorporated into the coating fluid. Examples thereof include ethylene oxide adducts of an ethylene polymer having 25 to 100 carbon atoms and linear saturated hydrocarbons such as paraffins.

In forming a resin substrate for optical use, a layer 6 may be superposed according to need on the easily peelable resin layer 5 as shown by an imaginary line (an alternate long and two-short dash line) in FIG. 1 so that a resin layer 7 serving as a base is formed thereon. In the example shown in the figure, a coating fluid for the superposition is continuously spread in a sheet form on the resin layer 5 through a die 61 by the same method as that used for the resin layer 5, and the resultant spread layer 62 is converted to a cured film with a curing apparatus 63 to thereby form the superposed layer 6.

The superposed layer optionally formed between the easily peelable resin layer 5 and the base layer 7 may be one for imparting an appropriate function such as, e.g., chemical resistance, optical anisotropy, low water absorption, low hygroscopicity, or gas barrier properties such as low permeability to oxygen. Consequently, the superposed layer which may be optionally formed may consist of a single layer or two or more layers.

Incidentally, in liquid-crystal cells, penetration of moisture or oxygen through the cell substrate into the cell may arouse troubles such as denaturation of the liquid crystal, a poor appearance due to bubbling, and breakage of a transparent conductive film pattern. Consequently, inhibition of the permeation of water vapor and oxygen gas is important for liquid-crystal cells, and a cell substrate having a gas barrier layer capable of inhibiting these gases from permeating therethrough is preferred for that application.

A coating fluid for forming the gas barrier layer can be prepared from a suitable material which is capable of inhibiting the permeation of a particular gas therethrough and can be liquefied. In general, a material which is highly impermeable to a particular gas, e.g., water vapor or oxygen gas, is used. In particular, a polymer having a low coefficient of oxygen permeability is used, such as, e.g., poly(vinyl alcohol), a partially saponified poly(vinyl alcohol), an ethylene/vinyl alcohol copolymer, polyacrylonitrile, or poly(vinylidene chloride). Especially preferred from the standpoints of gas barrier properties, evenness of moisture diffusion or water absorption, etc. is a poly(vinyl alcohol) type polymer.

The coating fluid for forming the layer, e.g., a gas barrier layer, to be superposed on the easily peelable resin layer can be prepared, for example, by bringing one or more film-forming materials into a flowable and spreadable state, such as that of a polymer solution, optionally with a solvent. The thickness of each layer, e.g., a gas barrier layer, to be superposed is not particularly limited and can be suitably determined. In general, the thickness thereof is preferably 15 μm or smaller, more preferably 10 μm or smaller, most preferably from 1 to 5 μm, from the standpoints of functions such as transparency, coloring prevention, and gas barrier properties and of thickness reduction, flexibility of the resin substrate for optical use to be obtained, etc. In the case of forming such a layer superposed on the easily peelable resin layer, the thickness of the easily peelable resin layer serving especially as a hard coat layer can be smaller than 1 μm and, in particular, 0.1 μm or larger. Even when the easily peelable resin layer has such a small thickness, it can be peeled from the support without breaking due to the reinforcing effect of the layer superposed thereon.

For preparing a resinous coating fluid to be spread on the easily peelable resin layer or on the layer superposed thereon to form a base layer, one or more suitable thermoplastic or curable resins can be used without particular limitations according to the intended use of the resin substrate for optical use, etc. In the case of obtaining, e.g., a cell substrate for use in forming a liquid-crystal cell, it is preferred to use an epoxy resin of the heat-curable or ultraviolet-curable type. This epoxy resin is not particularly limited in kind, and an appropriate one can be used.

Examples of the epoxy resin include the bisphenol types such as bisphenol A type, bisphenol F type, bisphenol S type, and hydrogenated epoxies derived from these, the novolak types such as phenol novolak type and cresol novolak type, the nitrogen-containing cyclic types such as triglycidyl isocyanurate type and hydantoin type, the alicyclic type, the aliphatic type, the aromatic type such as naphthalene type, the glycidyl ether type, the low-water-absorption type such as biphenyl type, the dicyclo type, the ester type, the etherester type, and modifications of these.

Preferred epoxy resins from the standpoints of unsusceptibility to discoloration upon curing, optical properties including transparency, etc. are the bisphenol A type, alicyclic type, and triglycidyl isocyanurate type. Preferred epoxy resins for use in forming a cell substrate or the like are ones having an epoxy equivalent of from 100 to 1,000 and giving a cured resin having a softening point of 120° C. or lower, from the standpoints of properties including rigidity and strength, etc.

Furthermore, from the standpoints of obtaining an epoxy resin coating fluid excellent in applicability and spreadability into a sheet form, etc., it is preferred to use a two-pack type epoxy resin which is liquid at temperatures not higher than the application temperature, in particular at room temperature. In this case, a solid epoxy resin can be used in combination with that epoxy resin for the purposes of viscosity regulation, improvement of strength or heat resistance, etc. Consequently, epoxy resins can be used alone or in combination of two or more thereof.

A curing agent can be incorporated into the epoxy resin coating fluid according to need. In the case where the epoxy resin coating fluid is of the heat-curable type, a curing agent is usually incorporated therein. The curing agent to be used is not particularly limited, and one or more suitable curing agents can be used according to the epoxy resin used. Examples thereof include organic acid compounds such as tetrahydrophthalic acid, methyltetrahydrophthalic acid, hexahydrophthalic acid, and methylhexahydrophthalic acid and amine compounds such as ethylenediamine, propylenediamine, diethylenetriamine, triethylenetetramine, amine adducts of these, m-phenylenediamine, diaminodiphenylmethane, and diaminodiphenyl sulfone.

Other examples of the curing agent include amide compounds such as dicyandiamide and polyamides, hydrazide compounds such as dihydrazide, and imidazole compounds such as methylimidazole, 2-ethyl-4-methylimidazole, ethylimidazole, isopropylimidazole, 2,4-dimethylimidazole, phenylimidazole, undecylimidazole, heptadecylimidazole, and 2-phenyl-4-methylimidazole.

Examples of the curing agent further include imidazoline compounds such as methylimidazoline, 2-ethyl-4-methylimidazoline, ethylimidazoline, isopropylimidazoline, 2,4-dimethylimidazoline, phenylimidazoline, undecylimidazoline, heptadecylimidazoline, and 2-phenyl-4-methylimidazoline, and further include phenol compounds, urea compounds, and polysulfide compounds.

Acid anhydride compounds also are included in examples of the curing agent. Such acid anhydride curing agents can be advantageously used from the standpoints of attaining a satisfactory working atmosphere due to their lowly irritating properties and obtaining a resin substrate for optical use which has improved heat resistance and hence has high-temperature durability and discoloration resistance. Examples thereof include phthalic anhydride, maleic anhydride, trimellitic anhydride, pyromellitic anhydride, nadic anhydride, glutaric anhydride, tetrahydrophthalic anhydride, methyltetrahydrophthalic anhydride, hexahydrophthalic anhydride, methylhexahydrophthalic anhydride, methylnadic anhydride, dodecenylsuccinic anhydride, dichlorosuccinic anhydride, benzophenonetetracarboxylic anhydride, and chlorendic anhydride.

Especially preferred from the standpoints of the discoloration resistance, etc. are acid anhydride curing agents which are colorless to light-yellow and have a molecular weight of about from 140 to 200, such as phthalic anhydride, tetrahydrophthalic anhydride, hexahydrophthalic anhydride, and methylhexahydrophthalic anhydride.

The amount of the curing agent to be used can be suitably determined according to the kind thereof, the epoxy equivalent of the epoxy resin, etc., and may be the same as in the usual curing of epoxy resins. It is generally preferred to use the curing agent in an amount of from 0.5 to 1.5 equivalents, preferably from 0.6 to 1.4 equivalents, more preferably from 0.7 to 1.2 equivalents, per equivalent of the epoxy groups from the standpoint of obtaining a resin substrate for optical use which is prevented from deteriorating in hue or moisture resistance.

Suitable additives such as, e.g., a curing accelerator and a leveling agent can be incorporated according to need in preparing the epoxy resin coating fluid. A curing accelerator is incorporated for the purpose of heightening the rate of curing and thereby reducing the curing time required. By the incorporation thereof, the length of the support necessary for the coating fluid containing no curing accelerator can be reduced to about a half or smaller. It is therefore preferred to incorporate a curing accelerator from the standpoints of improvement in suitability for mass production, size reduction in the apparatus for continuous production, etc.

The curing accelerator to be used is not particularly limited, and one or more suitable curing accelerators can be used according to the kinds of the epoxy resin and curing agent, etc. Examples thereof include tertiary amines, imidazole compounds, quaternary ammonium salts, organic metal salts, phosphorus compounds, and urea compounds. Preferred of these are tertiary amines and imidazole compounds. The amount of the curing accelerator to be used can be suitably determined according to its acceleration effect, etc. In general, however, the amount thereof is from 0.05 to 7 parts by weight, preferably from 0.1 to 5 parts by weight, more preferably from 0.2 to 3 parts by weight, per 100 parts by weight of the epoxy resin, from the standpoints of the discoloration resistance, etc.

On the other hand, a leveling agent is incorporated for the purpose of, e.g., forming a smooth surface by preventing a spread layer of the epoxy resin coating fluid from giving a satin surface due to, e.g., unevenness of surface tension resulting from the vaporization of the curing agent, etc. when the spread layer is cured in an air atmosphere. One or more suitable leveling agents capable of reducing surface tension can be used. Examples thereof include various surfactants such as silicone, acrylic, and fluorochemical surfactants. Preferred of these are silicone surfactants.

Examples of other additives which can be incorporated include antioxidants such as phenol compounds, amine compounds, organosulfur compounds, and phosphine compounds, modifiers such as glycols, silicones, and alcohols, antifoamers, hydroxy compounds, dyes and pigments, discoloration inhibitors, and ultraviolet absorbers. The antifoamers are added for the purpose of, e.g., obtaining a resin substrate for optical use which contains no bubbles causative of a decrease in optical properties. Preferred examples of the antifoamers are polyhydric alcohols such as glycerol.

In the case of an epoxy resin coating fluid to be cured by ultraviolet irradiation, a photopolymerization initiator or sensitizer and the like may be incorporated thereinto. As the photopolymerization initiator or sensitizer can be used a known one for use in the curing of epoxy resins with ultraviolet. Examples thereof include allyldiazonium salts, benzophenone, and benzoin.

The resinous coating fluid for forming a base layer can be prepared by bringing the ingredients for the coating fluid into a flowable and spreadable state with a solvent according to need. This coating fluid can have a suitably determined viscosity. In general, however, the coating fluid is preferably spread on the support at a viscosity of 10 P or higher, preferably from 30 to 500 P, more preferably from 150 to 300 P, from the standpoints of improving thickness precision by diminishing thickness unevenness and of application efficiency, improvement of surface smoothness based on the formation of a free surface, etc.

Especially in extrusion coating, it is preferred that the coating fluid regulated so as to have a viscosity of from 150 to 300 P be spread on the easily peelable resin layer or another layer through a die regulated so as to have a temperature of from 10 to 40° C., preferably from 15 to 35° C., more preferably from 20 to 30° C., and temperature fluctuations within ±0.5° C., preferably within ±0.3° C., more preferably within ±0.1° C., from the standpoints of improving thickness precision and surface smoothness, etc.

The width over which the resinous coating fluid for forming a base layer is to be spread is preferably at least 90% of the width of the support, more preferably at least 95% thereof, and most preferably almost the same as the support width, from the standpoints of regulating the balance of the support, thus inhibiting the coating layer from flowing due to inclination or deformation of the support to come to have thickness unevenness, and thereby producing a substrate having improved thickness precision, etc. It is therefore preferred, from the standpoint of attaining evenness of film thickness, that the support be capable of supporting the spread layer while keeping it as horizontal as possible. Incidentally, when the level of the support during the curing of the coating fluid is kept at a value not larger than 1 mm per 5 times, preferably 20 times, more preferably 40 times the desired effective width of the cured resin layer to be formed, then the resin substrate for optical use to be formed can have a thickness precision of within ±15%, preferably within ±10%.

The spread layer of the resinous coating fluid for forming a base layer on the easily peelable resin layer or another layer may be subjected to a curing treatment according to need. This curing treatment can be conducted by a technique suitable for the resin, such as, e.g., thermal curing or ultraviolet curing. Two or more curing techniques may be used in combination. From the standpoint of the heat resistance of the cured resin layer to be obtained, thermal curing is usually preferred. In this curing treatment, it is preferred to regulate the support so as to have width-direction temperature fluctuations within +0.5° C./cm, preferably within ±0.3° C./cm, more preferably within ±0.1° C./cm, from the standpoints of obtaining a cured resin layer having improved thickness precision and reduced optical strain, etc, by controlling viscosity flactuations of the resinous coating fluid in the course of curing the spread layer thereof.

Although the width-direction temperature control of the support can be conducted in an appropriate technique, it is preferred to employ a technique in which temperature can be controlled according to the progress of curing of the spread layer, from the standpoints of improving thickness precision, diminishing optical strain, etc. In a technique preferred from this standpoint, the curing apparatus is partitioned into up to ten zones, preferably into two to six zones, and these zones are independently temperature-controlled with respective means for heating. In the example shown in the figure, the heating apparatus 4 has been partitioned into five zones so that the heating temperature in each zone is regulated to control the viscosity of the spread layer. With respect to the level of the support, an inclination thereof can be detected by horizon sensors 41 and be corrected with guide rolls 42 based on the detection.

The temperature control can be accomplished, for example, by regulating heating conditions including heating time, temperature, and heating rate. However, a technique preferred from the standpoint of rapid temperature control is, for example, one in which means for heating are disposed over and/or under the support, and the support is heated on both the upper and the lower sides with the heating means or heated by a combination thereof with heating on the upper or lower side only. As the heating means can be used one or more appropriate means such as, e.g., hot air and infrared heaters.

In the case where the spread layer is cured by heating, the heating means for this curing can serve also as heating means for the support. Heating conditions in this thermal curing generally include a heating temperature of from 30 to 250° C., preferably from 45 to 220° C., more preferably from 60 to 170° C., and a heating time of from 5 to 60 minutes, preferably from 10 to 40 minutes, more preferably from 15 to 30 minutes. However, the heating conditions should not be construed as being limited to these.

From the standpoints of improving optical properties, etc., it is preferred to use a relatively short heating time of, e.g., from 15 to 30 minutes. In the case of heating with hot air, the wind velocity is preferably from 0.1 to 5 m/sec, more preferably from 0.1 to 3 m/sec, most preferably from 0.2 to 1 m/sec, from the standpoints of improving thickness precision, etc. From the standpoint of further improving thickness precision, it is preferred to minimize temperature differences in the spread layer in the width direction.

As a result of the curing treatment described above, the cured resin layer usually adheres satisfactorily to the easily peelable resin layer or another layer and is united therewith. Thus, a resin substrate for optical use is formed in which those layers can be handled as a united structure. In the case of a curing treatment with ultraviolet or the like, this treatment can be conducted in the same manner as for the easily peelable resin layer described above. A curing treatment comprising a combination of curing with heating and curing with ultraviolet or the like can also be used.

The resin substrate for optical use to be formed can have an average thickness of from 100 to 800 μm suitably determined according to the intended use thereof. In applications such as liquid-crystal cell substrates, average thicknesses of from 200 to 500 μm are advantageous in many cases from the standpoints of rigidity or flexibility, including flexural strength, and of surface smoothness, phase difference reduction, and thickness and weight reduction.

For use as liquid-crystal cell substrates or the like, the resin substrate preferably has a thickness precision of within ±20%, preferably within ±15%, more preferably within ±10%. In particular, the width-direction thickness precision thereof is preferably within ±15%, more preferably within ±10%. Although a heightened width-direction thickness precision can be attained by cutting and removing an edge part from each side of the resin substrate for optical use obtained, this operation produces a cutting loss and results in a reduced yield. In the invention, it is therefore preferred to form a resin substrate for optical use which is as wide as possible and has the desired thickness precision.

In the process for continuous production described above, the resin substrate for optical use formed is recovered from the support preferably by peeling the resin substrate either in an atmosphere having a high temperature around the glass transition temperature or under the influence of a shrinkage stress resulting from rapid cooling. This method is preferred from the standpoints of cracking prevention, etc. In particular, from the standpoint of attaining balanced flexibility capable of preventing cracking, plastic deformation, and generation of residual strain, it is preferred to peel the resin substrate at a temperature not lower than the temperature lower by 20° C. than the glass transition temperature of the base layer, preferably at a temperature in the range of ±10° C. based on the glass transition temperature. Consequently, from the aforementioned standpoints of preventing cracking, strain, etc., the resin substrate for optical use obtained is preferably recovered after the substrate has cured to such a degree as not to suffer a plastic deformation even at high temperatures around the glass transition temperature.

A means for peeling can be used according to need in recovering the resin substrate for optical use from the support. For example, the resin substrate can be efficiently peeled and recovered by the method shown in the figure. Specifically, after the formation of a resin layer or the formation of an optional layer superposed thereon, a reinforcing tape is bonded, e.g., to each edge of the layer(s). A base resin layer is formed thereon, and the reinforcing tape is then held and lifted up to thereby efficiently recover the resin substrate for optical use from the support. The continuous resin substrate for optical use thus formed can be recovered after having been cut into an appropriate size by an appropriate means for cutting, e.g., a laser beam, ultrasonic cutter, dicing, or water jet.

The resin substrate for optical use according to the invention can be advantageously used in various applications like conventional resin substrates. Examples of such applications include the cell substrates of various cells including liquid-crystal cells and the covers of touch panels, electromagnetic shields, and solar cells. The resin substrate for optical use can be obtained as an opaque structure, for example, by coloring suitable one or more of the easily peelable resin layer, layer superposed thereon, and base layer. However, in the case where the resin substrate is required to transmit light as in cell substrates, all the layers constituting the substrate are formed as transparent layers.

The liquid-crystal cell substrate is preferably a resin substrate for optical use which has a glass transition temperature of 120° C. or higher, preferably 130° C. or higher, more preferably 140° C. or higher, from the standpoint of enabling the substrate to withstand the high-temperature atmosphere and other conditions used in the production of a liquid-crystal cell. The glass transition temperature can be determined by TMA (thermomechanical analysis) in the tensile mode under the conditions of a heating rate of 2° C./min. In forming a liquid-crystal cell employing the resin substrate for optical use according to the invention, various functional layers such as, e.g., a transparent conductive film, alignment film, polarizer plate, and phase difference plate can be superposed according to need in a conventional manner. The liquid-crystal cell to be formed may be any type, e.g., the TN type, STN type, TFT type, or ferroelectric liquid-crystal type.

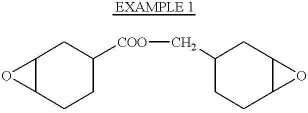

An epoxy resin coating fluid having a viscosity of 200 P at 25° C. was prepared by mixing 400 parts (parts by weight; the same applies hereinafter) of 3,4-epoxycyclohexylmethyl 3,4-epoxycyclohexanecarboxylate, represented by the formula given above, with 500 parts of methylhexahydrophthalic anhydride, 15 parts of tetra-n-butylphosphonium o,o-diethylphosphorodithioate, represented by the following formula, 9 parts of glycerol, and 1 part of a silicone surfactant with stirring.

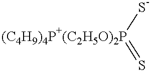

Subsequently, a 17 wt % toluene solution of an ultraviolet-curable urethane resin was extruded through a die by the flow casting method shown in FIG. 1 and applied to a stainless-steel endless belt which was kept running at a constant speed of 0.2 m/min and had a width of 500 mm and a surface roughness Rₐ of 10 nm. The toluene was vaporized to dry the coating. The resultant coating layer was irradiated with ultraviolet (254 nm) in a dose of 2,000 mJ/cm² by means of a low-pressure mercury lamp to cure the resin and thereby form a urethane resin layer having a width of 500 mm and a thickness of 2 μm.

While continuing the operation described above, a 5.5 wt % aqueous solution of poly(vinyl alcohol) was extruded through a die and applied on the cured urethane resin layer by flow casting and the coating was dried at 60° C. for 10 minutes to form a poly(vinyl alcohol) layer having a width of 450 mm and a thickness of 4 μm which overlay the urethane resin layer. A pressure-sensitive adhesive tape employing a heat-resistant polyester base and having a width of 40 mm (MT-3155, manufactured by Nitto Denko Corporation) was adhered to the superposed layers along each edge in the width direction.

Subsequently, the epoxy resin coating fluid obtained above was continuously extruded through a 25° C. die and spread in a 430 mm-wide sheet form on the poly (vinyl alcohol) layer, while continuing the operations for forming the urethane resin layer and poly(vinyl alcohol) layer and for adhering the pressure-sensitive adhesive tape and maintaining a support level of 200 μm/m. The spread layer was cured by heating first at 90° C. for 5 minutes, subsequently at 120° C. for 5 minutes, and then at 140° C. for 15 minutes. This heating was conducted by passing the web successively through the zones of a curing apparatus of the type in which the support was heated with hot air from the upper and lower sides, while maintaining a temperature change of 0.4° C./cm or smaller in the width direction for the support. Thereafter, the cured resin layer was peeled and recovered over the subsidiary drum kept at 130° C. from the endless belt with the pressure-sensitive adhesive tapes together with the urethane resin layer and poly (vinyl alcohol) layer tenaciously adherent thereto. Thus, a resin substrate for optical use having a width of 430 mm was continuously obtained. This resin substrate was cut into a 430-mm square.

The thickness of the resin substrate for optical use obtained by the process described above at 240 hours after initiation of the production was measured with a laser thickness meter with respect to 60 points in an inner 420 mm-square area thereof. The average thickness thereof and the standard deviation were determined, and were found to be 400 μm and 7 μm, respectively. Furthermore, the surface roughness Rₐ of each of the front and back sides of the resin substrate for optical use was measured with respect to 10 points in an inner 420 mm-square area thereof. As a result, the average thereof was 0.2 nm on the free surface side made of the epoxy resin, and was 10 nm on the other surface side made of the urethane resin, which surface side was peeled from the belt.

### COMPARATIVE EXAMPLE

Two 450 mm-square, stainless-steel flat plates having a surface roughness Rₐ of 15 nm each was coated on one side with a urethane resin layer having a thickness of 2 μm in the same manner as in Example 1. The coated stainless-steel plates were disposed so that the coated sides thereof faced each other through a spacer and a sealing material to thereby fabricate a mold having a gap width of 400 μm. The epoxy resin coating fluid was injected into the mold and cured by heating first at 120° C. for 30 minutes and then at 150° C. for 1 hour. Thereafter, the mold was opened to obtain a resin substrate, which was cut into a 430-mm square. This resin substrate was examined for average thickness, standard deviation, and surface roughness in the same manner as in Example 1. As a result, the average thickness and standard deviation thereof were 400 μm and 9 μm, respectively. The surface roughness Rₐ thereof was 15 nm on each side.

### EVALUATION TEST

An ITO film was sputtered on the epoxy resin layer of each of the resin substrates obtained in Example 1 and Comparative Example. On each ITO film was formed a rubbed poly(vinyl alcohol) film. Two such coated resin substrates were disposed face to face at a distance of 4 μm. A commercial nematic liquid crystal containing a chiral reagent was packed into the gap, which was then sealed to form an STN type liquid-crystal cell. Thereto was adhered a phase difference film for compensating for black displaying. This liquid-crystal cell was examined with a polarizing microscope while applying a voltage thereto to keep the cell in the black displaying mode. As a result, the cell of Example 1 showed satisfactory black displaying and no alignment defects were observed therein, whereas light leakage was observed in the cell of Comparative Example due to alignment defects.

While the invention has been described in detail and with reference to specific embodiments thereof, it will be apparent to one skilled in the art that various changes and modifications can be made therein without departing from the spirit and scope thereof.

What is claimed is:

1. A resin substrate for optical use which comprises a multilayer structure having a surface roughness Rₐ of 0.8 nm or lower on at least one side and having an average thickness of from 100 to 800 μm.

2. The resin substrate for optical use of claim 1, which has a layer of a cured epoxy resin.

3. The resin substrate for optical use of claim 1 or 2, which has a transparent hard coat layer having a thickness of 0.1 μm or larger as a surface layer and a poly(vinyl alcohol)-based gas barrier layer as a superposed layer underlying the hard coat layer.

4. The resin substrate for optical use of claim 1, wherein the surface roughness Rₐ is 0.2 nm or lower.

5. The resin substrate for optical use of claim 1, wherein the average thickness is from 200 to 500 μm.

6. The resin substrate for optical use of claim 2, wherein the epoxy resin is selected from the group consisting of a bisphenol A type epoxy resin, an alicyclic type epoxy resin, and a tryglycidyl isocyanurate type epoxy resin.
